(19) United States
(12) Patent Application Publication
(10) Pub. No.: US 2006/0055773 A1
(43) Pub. Date: Mar. 16, 2006

(54) Device and method for stereoscopic reproduction of picture information on a screen

(75) Inventor: Robert Kutka, Geltendorf (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munich (DE)

(21) Appl. No.: 11/070,831

(22) Filed: Mar. 3, 2005

(30) Foreign Application Priority Data
Mar. 3, 2004 (DE) 10 2004 010 369.0

(51) Int. Cl. H04N 13/04; H04N 15/00

(52) U.S. Cl. 348/51

(57) ABSTRACT

A method stereoscopically reproduces still or moving pictures on an individual screen. Images are arranged next to one another on a screen by software for a left and a right stereoscopic presentation. So that for the two eyes of the observer the correct image is visible in each case, an optical accessory is attached to the screen. This features at a distance between the eyes of the observer lenses which sharply display to the observer the two subimages shown on the screen. Depending on the size of the screen the optical path of the two subimages may be diverted by optical components.

### CROSS REFERENCE TO RELATED APPLICATIONS

This application is based on and hereby claims priority to German Application No. 10 2004 010 369.0 filed Mar. 3, 2004, the contents of which are hereby incorporated by reference.

### BACKGROUND OF THE INVENTION

The present invention relates to a device and a method for the stereoscopic reproduction of picture information on a screen. To this ends images must be visible for the left and the right eye of the observer which differ perspectively such that a three-dimensional visual impression can be produced. This can be done for both still and moving images.

Methods are known in which the screen is viewed with spectacles which convey the correct visual impression to both eyes, with the screen displaying the two images alternately. The spectacles must now alternately hide the visual impression to the left and the right, so that each eye can always only capture the correct image in each case. This requires the spectacles to be synchronized with the presentation on the screen which changes with each individual image between the images for the left and the right eye. Two methods are currently used for this purpose.

With the shutter spectacles one side of the spectacles is darkened in each case. This occurs synchronously with the refresh rate of the screen.

With the use of polarization filters spectacles are used which feature passive polarization filters on both sides for which the orientation differs by 90°. An active polarization foil is applied in front of the screen which can be switched between the orientation of the two polarization filters of the spectacles, so that the visual impression will be extinguished for one eye in each case.

So that with this method each eye obtains a flicker and jerk-free visual impression of still and moving pictures, the screen refresh rate of the screen must lie above the known rates. With LED displays in particular, which for known use remain flicker-free thanks to their static display despite low refresh rates, the alternate hiding of the image leads to flickering. The necessary increase in the screen refresh rate is however difficult to implement, particularly with organic LEDs since their reaction times are not short enough. Both methods are expensive and only suited under some conditions to non self-illuminating displays.

A further known approach resorts to using lens raster screens which show both images simultaneously transposed within one another. It is not necessary to wear spectacles with this method. The result of the lens raster is that from the viewing perspective of the eyes of the observer, only the screen pixels are visible which belong to the image which is intended for the relevant eye. This approach makes it necessary to precisely adapt the lens raster to the screen. This method is also expensive and only suited under some conditions for use with cathode ray tube monitors, since it imposes high demands on accuracy with regard to distortions.

### SUMMARY OF THE INVENTION

One possible object of the invention is thus to develop a low-cost alternative for stereoscopic reproduction of picture information on a screen, without imposing increased demands on the reaction time and freedom from distortion of the screen in doing so.

When the screen features a visible image width which is approximately twice the distance between the observer's eyes, the distance between lens and screen in accordance with an embodiment corresponds to the focal length of the lens, with the images on the screen preferably being offset from one another at approximately the distance between the observer's eyes.

If the screen features a visible image width which is less than twice the distance between the observer's eyes, the optical path of the two subimages in accordance with a further embodiment is redirected by optical components so that through the lenses a central image of the relevant subimage is visible, and the length of the optical path corresponds to the focal length of the lenses.

If the screen features a visible screen width which is more than twice the distance between the observer's eyes, the optical path of the two images in accordance with a further embodiment is diverted by optical components a centered image of the relevant subimage is visible through the lens, and the length of the optical path corresponds to the focal length of the lens.

If the housing is attached to an external screen it includes an attachment device. The advantage of this embodiment is that existing non-stereoscopic screens can be cheaply upgraded for stereoscopic image reproduction.

If the screen is not self-illuminating, the housing preferably features light openings or transparent parts so that the screen surfaces can be illuminated by ambient light. The housing is thus also suitable for non-self-illuminating screens.

Preferably the housing will be used with a mini screen, such as that of a video mobile phone or of a PDA.

The method for stereoscopic reproduction of picture information is designed so that software presents on a screen on a left and right half images for a left and right stereoscopic view arranged next to each other, and these images are made visible to the observer by two lenses, which are accommodated in a housing permanently attached to the screen at roughly the distance between an observer's eyes, so that these can produce a three-dimensional visual impression.

When the screen features a visible image width which is approximately twice the distance between the observer's eyes, the images on the screen are preferably offset from one another by approximately the distance between the observer's eyes and the lens is arranged at a distance of its focal length away from the screen.

If the screen features a visible image width which is less than twice the distance between the observer's eyes the optical path of the two subimages is diverted by optical components such that the lens shows a centered image of the relevant subimage and the length of the optical path correspond to the focal length of the lens.

If the screen features a visible image width which is more than twice the distance between the user's eyes, the optical path of the two subimages is diverted by optical components such that the lens shows a centered image of the relevant subimage and the length of the optical path correspond to the focal length of the lens.

In accordance with an embodiment the housing can also be attached by a fixing unit retroactively to an external non-stereoscopic screen to upgrade it at low cost in conjunction with corresponding software for stereoscopic display.

Non-self-illuminating screens can also be used—in this case the housing preferably features light openings or transparent parts so that the screen surfaces are illuminated by ambient light.

Preferably the method is used for stereoscopic reproduction of still and moving images on mini displays. The device and the method impose no demands on the screen regarding reaction times or accuracy in relation to distortions, meaning that any, even low-cost screens can be used. Furthermore the device does not have to be worn on the head like spectacles By contrast with known approaches, the device and the method can be implemented at low cost.

Capturing and calculation of stereoscopic views may not be important, but the reproduction on an individual screen is important, unlike systems with a plurality of screens as are used for example with data spikes.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is an abstracted view of housing and screen in cross-section,

FIG. 2 is a front view of the screen,

FIG. 3 is an overhead view of the device in cross-section for a visible screen width of for example 13 cm,

FIG. 4 is an overhead view of the device in cross-section for a visible screen width of less than 13 cm, e.g. 6 cm,

FIG. 5 is an overhead view of the device in cross-section for a visible screen width of more than 13 cm, e.g. 36 cm.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

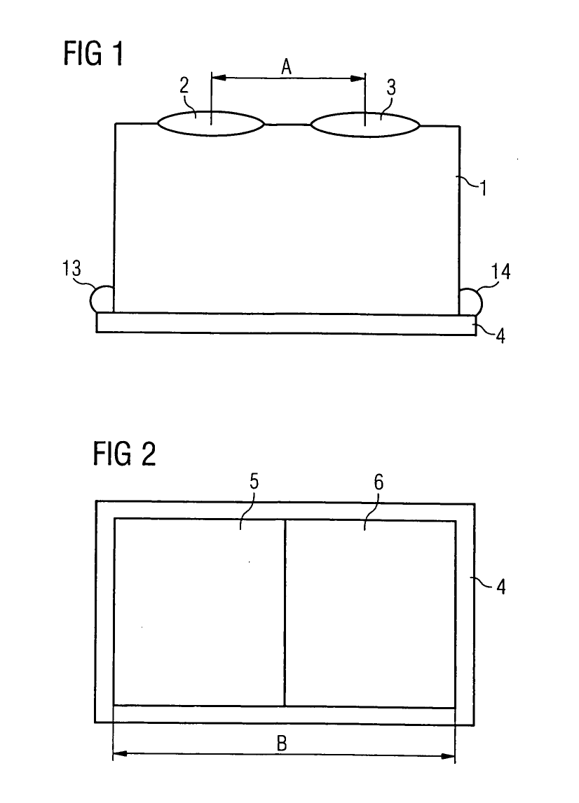

The device in accordance with FIG. 1 has a housing 1 which is permanently connected to screen 4. If an existing non-stereoscopic screen 4 is to be retrofitted for stereoscopic reproduction of images and videos, the housing can be retrofitted to the screen using attachment devices 13 and 14. Hooks and eyes might be used as attachment devices 13, 14 with which the housing can be firmly attached to the screen 4. On the front of the housing 1 at roughly the distance A between the observer's eyes two lenses 2 and 3 are fitted which show the observer a left and right stereoscopic view, so that a three-dimensional visual impression can be obtained. Spacing A is taken to mean the distance between the center points of the observer's pupils, which is also referred to as the pupil distance. The values here for adults are on average 65 mm, maximum 70 mm, and for children are far less than this.

The images for the left and right stereoscopic view in accordance with FIG. 2 are displayed by software arranged alongside one another in the left and right halves 5 and 6 of the screen 4. The screen width B of the screen 4 is taken to mean the horizontal extent of a visible image. The distance between the two images for the left and the right stereoscopic view on the screen 4 always, means the distance between their mid points; The distance is thus not zero Under any circumstances, even if the edges of the two images on the screen 4 immediately adjoin one another. The distance between lenses 2 and 3 is also always taken to mean the distance between their mid points.

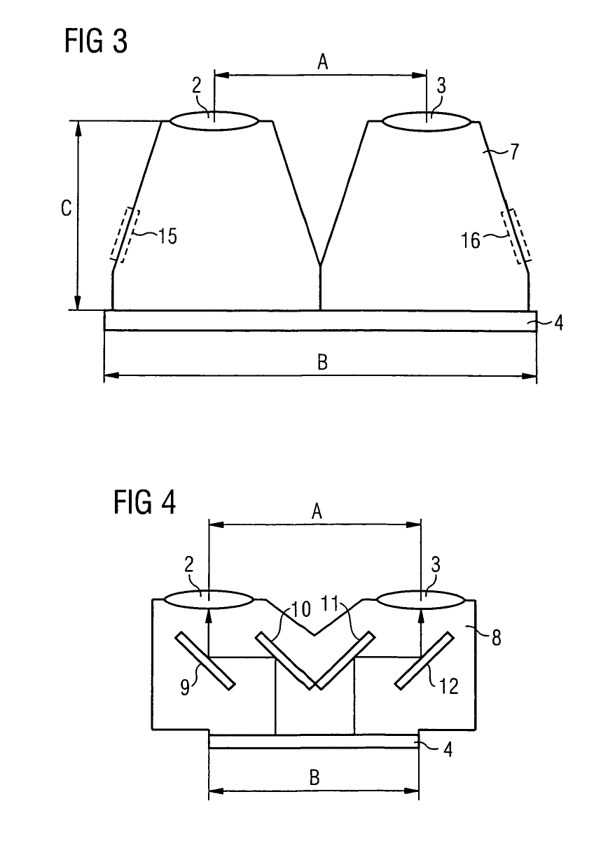

FIG. 3 shows an exemplary embodiment of the invention for the case in which the visible screen width B of the screen 4 corresponds to approximately double the distance A between the observer's eyes, i.e. it lies in the range of between 10 and 15 cm. In this case the housing 7 is designed so that the distance between lens 2 and 3 and screen 4 corresponds to the focal length C of lens 3. The lenses 2 and 3 are again fitted at around the distance between an observer's eyes A from one another on the housing 7. They show an image of the left half 5 or the right half 6 of the screen 4 (cf. FIG. 2). In the left half 5 or the right half 6 of the screen images for a left or right stereoscopic view are arranged next to one another. In the exemplary embodiment shown in FIG. 3 the two images are offset from each other on the screen 4 preferably by about the distance between the eyes A of the observer. The housing 7 features light openings or transparent parts 15 and 16, through which the ambient light reaches the screen surface of the screen 4. The screen surface of the screen 4 is thus sufficiently illuminated so that even a non-self-illuminating screen 4 can be used.

FIG. 4 shows an exemplary embodiment of the invention for the case in which the visible screen size B of the screen 4 is less than twice the distance between the eyes A of the observer. This can be the case for example with a visible screen width B of less than 10 cm. In this variant the images for the left and the right stereoscopic view will not be shown in the distance between the eyes A of the observer on the screen 4, since this is too small. The two images in the left half 5 and the right half 6 of the screen 4 (cf. FIG. 2) are thus arranged at a smaller distance from each other. In accordance with FIG. 4 the optical path of the two images for the left and right stereoscopic view is diverted by optical components 9, 10, 11, 12 of a modified housing 8 such that the lenses 2 and 3, which are also arranged at approximately the distance A between the observer's eyes, show the observer a centered image of the left or right stereoscopic view, so that the latter can obtain the visual impression of a three-dimensional image. The length of the optical path of the two images corresponds here to the focal length of lenses 2 and 3.

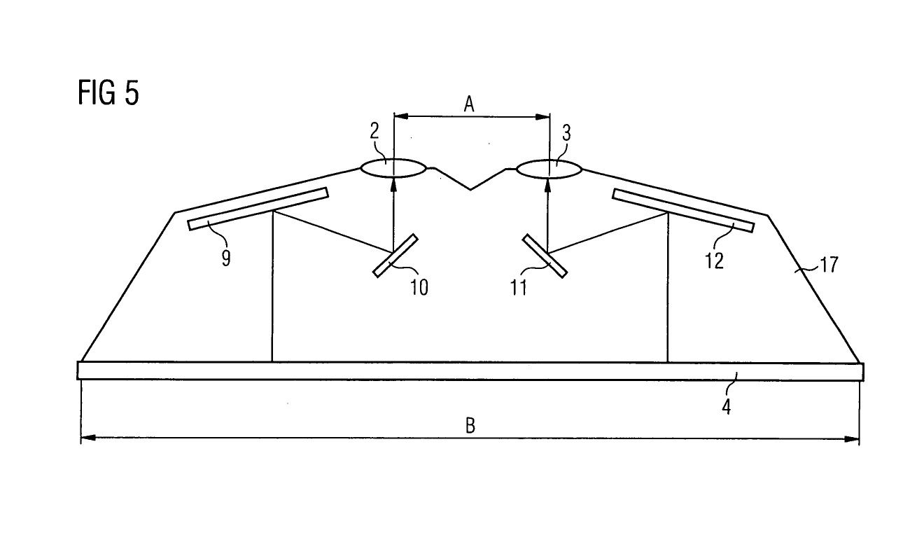

FIG. 5 shows an embodiment of the invention for the case in which the visible screen width B of the screen 4 is more than double the distance between the eyes A of the observer. This is for example the case with a commercially available PC screen with a visible screen width of around 30 cm. Although with such a screen 4 the embodiment in accordance with FIG. 3 can also be used, the edge areas of the screen 4 then remain unused, since the images for the left and right stereoscopic view must be displayed at around the distance between the eyes A of the observer. FIG. 5 now shows an embodiment, in which even a screen 4 with a large screen width B can be used. To this end the images for the left and right stereoscopic view are displayed next to one another in the left half 5 and the right half 6 of the screen 4 (cf. FIG. 2), with the distance between them being able to exceed the distance between the observer's eyes. The images for the left and right stereoscopic view can also for example be arranged centered in the left half 5 and the right half 6 of the screen 4 next to one another, where their distance then corresponds to half the visible screen width B of the screen 4. So that the lenses 2 and 3, which are also mounted here at around the distance A between the eyes of the observer on a modified housing 17 show the observer a centered image of the two stereoscopic views, their optical path must be correspondingly diverted by optical components 9, 10, 11, 12, with the length of the optical path of the two images again corresponding to the focal length of the lenses 2 and 3. Mirrors are typically suited for use as optical components.

For the embodiment shown in FIG. 5 the housing 17 will be fixed to the screen 4 during manufacturing. There is no provision for retrofitting the housing 17 to an external screen 4 or for separating the housing 17 from the screen 4. Therefore this embodiment does not feature any attachment devices either. The same applies to the embodiments shown in FIGS. 3 and 4. However the variants shown in FIGS. 3 to 5 can also be designed so that they feature attachment devices 13 and 14 (cf. FIG. 1), so that a non-stereoscopic screen 4 can be upgraded by attaching a housing 7, 8 or 17 for stereoscopic reproduction of image information. Conversely it is also conceivable, for the embodiment shown in FIG. 1, to dispense with the attachment devices 13 and 14 and connect the housing 1 permanently to the screen 4 at the manufacturing stage. Further variants provide for the light openings or transparent housing parts 15 and 16 shown in FIG. 3 to be embodied for the housings 1, 8 and 17 of the embodiments shown in FIGS. 4 and 5, so that, in these cases too, a non-self-illuminating screen 4 can be used. Conversely it would also be possible, for the embodiment shown in FIG. 3, to dispense with the light openings or transparent parts 15 and 16, so that the housing 7 can only be operated with a self-illuminating screen.

The invention has been described in detail with particular reference to preferred embodiments thereof and examples, but it will be understood that variations and modifications can be effected within the spirit and scope of the invention covered by the claims which may include the phrase “at least one of A, B and C” or a similar phrase as an alternative expression that means one or more of A, B and C may be used, contrary to the holding in Superguide v. DIRECTV, 69 USPQ2d 1865 (Fed. Cir. 2004).

What is claimed is:

1. A device for the stereoscopic reproduction of picture information on a screen, comprising:
a housing permanently attached to the screen; and
two lenses mounted in the housing and separated by a distance approximately equal to a distance between eyes of an observer such that an image of a left half or a right half of the screen is visible therethrough,
wherein, on the screen, respective subimages for a left and a right stereoscopic view are shown arranged next to one another in the left half and the right half.

2. The device in accordance with claim 1, wherein
the screen has a visible width which is approximately twice the distance between the eyes of the observer,
the distance between lenses and screen corresponds to a focal length of the lenses,
and the subimages on the screen are offset by approximately the distance between the eyes of the observer in relation to one another.

3. The device in accordance with claim 1, wherein
the screen has a visible screen width which is less than twice the distance between the eyes of the observer,
an optical path of each of the subimages is diverted by optical components so that a centered image of one of the subimages is visible through the lenses,
and the length of the optical path corresponds to a focal length of the lenses.

4. The device in accordance with claim 1, wherein
the screen has a visible screen width which is more than twice the distance between the eyes of the observer,
an optical path of each of the subimages is diverted by optical components so that a centered image of one of the subimages is visible through the lenses,
and the length of the optical path corresponds to the focal length of the lenses.

5. The device in accordance with claim 1, further comprising at least one attachment device with which the housing can be attached to an external screen.

6. The device in accordance with claim 1, wherein the housing includes light openings or transparent parts which allow ambient light to illuminate the image surfaces.

7. A method of stereoscopic reproduction of picture information, comprising:
displaying on a screen, in a left half and right half thereof, subimages for a left and a right stereoscopic view arranged next to one another; and
displaying the subimages through two lenses which are mounted in a housing and separated by a distance approximately equal to a distance between eyes of an observer, the housing being permanently attached to the screen so that a three-dimensional visual impression can be obtained.

8. The method in accordance with claim 7, wherein the screen has a visible screen width which is approximately twice the distance between the eyes of the observer, the subimages are shown offset next to each other on the screen by about the distance between the eyes of the observer and the lenses are arranged at a distance of their focal length from the screen.

9. The method in accordance with claim 7, wherein the screen has a visible screen width which is less than twice the distance between the eyes of the observer and an optical path of each of the subimages is diverted by optical components such that the lenses show a centered image of one of the subimages and a length of the optical path corresponds to the focal length of the lenses.

10. The method in accordance with claim 7 wherein the screen has a visible screen width which is more than twice the distance between the eyes of the observer, and an optical path of each of the subimages is diverted by optical components so that the lenses show a centered image of one of the subimages and a length of the optical path corresponds to the focal length of the lenses.

11. The method in accordance with claim 7, wherein the housing is mounted via at least one attachment device on an external non-stereoscopic screen.

12. The method according to claim 11, wherein the displaying is achieved via software and the at least one attachment device mounts the housing so that stereoscopic display is achieved from the non-stereoscopic screen via the software.

13. The method in accordance with claim 7, wherein the housing includes light openings or transparent parts which allow ambient light to illuminate the image surfaces.

14. A stereoscopic image reproduction device, comprising:
a housing attached to a screen, the screen being divided into a left half and a right half;
a pair of lenses respectively corresponding to the halves of the screen, mounted in the housing at a first distance from the screen, and being separated from each other by a second distance;
wherein first and second sub-images for respective left and right stereoscopic views are respectively displayed on the left half and the right half.

15. The device according to claim 14, wherein each of the pair of lenses has a specified focal length and the first distance is corresponds to the specified focal length.

16. The device according to claim 14, wherein the second distance is about a distance between eyes of an observer.

17. The device according to claim 16, wherein the second distance is a distance between midpoints of each of the pair of lenses.

18. The device according to claim 14, wherein the screen has a viewable width of about twice a distance between eyes of an observer.
